(19) United States
(12) Patent Application Publication
(10) Pub. No.: US 2014/0028674 A1
(43) Pub. Date: Jan. 30, 2014

(54) SYSTEM AND METHODS FOR THREE-DIMENSIONAL REPRESENTATION, VIEWING, AND SHARING OF DIGITAL CONTENT

(71) Applicant: Ahmed Medo Eldin, Sacramento, CA (US)

(72) Inventor: Ahmed Medo Eldin, Sacramento, CA (US)

(21) Appl. No.: 13/948,780

(22) Filed: Jul. 23, 2013

Related U.S. Application Data
(60) Provisional application No. 61/675,146, filed on Jul. 24, 2012.

(51) Int. Cl. G06T 15/04

(52) U.S. Cl. CPC G06T 15/04
USPC 345/420

(57) ABSTRACT

A digital content delivery system configured to aggregate user-selected digital content objects (tile) into a three-dimensional (3-D) object representation having a user-specified geometric output shape (texture). Renderings of tiles may form the texture such that perimeters of adjacent pairs of renderings are substantially abutting. A 3-D display of the texture may be rotatable about a 3-D Cartesian coordinate system with respect to a geometric center of the texture to alter the set of renderings viewable by a user. User selection of a rendering on the 3-D display retrieves a tile(s) associated to that rendering. Users may add, delete, and/or move renderings on a texture, as well as change the geometric output shape. Deployment of the digital content delivery system in multiple computing environments allows collaborative development and/or sharing of textures among multiple users.

### RELATED APPLICATIONS

This application claims the benefit Under 35 U.S.C. §119(e) of U.S. Provisional Patent Application Ser. No. 61/675,146 filed on Jul. 24, 2012 and titled System and Methods for Three-Dimensional Navigation and Viewing of Digital Images, the entire contents of which are incorporated herein by reference.

### FIELD OF THE INVENTION

The present invention relates to the field of digital content delivery and, more specifically, to representation of multiple digital objects for purposes of navigation, viewing, and sharing, and associated systems and methods.

### BACKGROUND OF THE INVENTION

Digital content has been growing in popularity since the first digital camera was made commercially available in 1990. Advancements in digital imaging technology have enabled consumers to capture, store, and share large numbers of digital photographs without incurring the incremental expense associated with the comparatively slow and costly alternative of traditional film and photo processing. In the subsequent decades, the introduction of electronic transmission means such as email, Internet, and wireless distribution has allowed consumers to rapidly and inexpensively exchange with others large numbers of digital content objects including not only images, but also, video, audio, graphics, and more.

Today, consumers increasingly are transferring digital content by accessing the Internet through a smart phone or tablet. This consumer trend is a result of a convergence of economic, social, and technological forces. As handsets and smart phone operating systems become more affordable, consumers are increasingly purchasing camera- and video-enabled smart phones. Adoption of this smart phone technology has caused a dramatic increase in digital content creation and sharing in the context of social networking. Furthermore, 3G/4G wireless connectivity is allowing people to consume digital content virtually anytime and anywhere. The resultant volume of shared digital content can be overwhelming to the average user. One clear problem with the use of smart phones is that there is sometimes too little screen space to accommodate the volume of content. Accordingly, because users are producing and/or receiving voluminous digital content that they want to access on their smart phones, difficulties have arisen due to small screen constraints associated with smart phones.

Various approaches exist in the art for attempting to manage large volumes of digital images. Since the 1990s, electronic photo albums commonly have been used to store and share digital content files such as digital photographs, particularly when the number of images grows large enough to complicate navigation to a desired image for viewing and/or sharing purposes. Electronic photo albums offer advantages over traditional multi-slot hardcopy photo albums including, but not limited to, increased storage capacity, secure archival capability, powerful editing tools, automated image indexing, image sharing features, album access controls, and collaborative production mechanisms.

However, the two-dimensional content delivery and management paradigms that currently dominate the digital technology landscape do not allow users to collaboratively aggregate, navigate, and share content in a natural and intuitive way. For example, some electronic photo albums present images in a list view. This navigation and display approach uses a text-based display method in which the file names of the electronic images are presented in some hierarchy. Text-based file descriptions, however, may not adequately describe the visual contents of the electronic photograph. Accordingly, a user may be required to open individual image files to ascertain the contents. This process can prove to be quite time consuming.

Other electronic photo albums present images in a thumbnail view. This approach typically employs a graphical grid-based display in which miniature versions of each photo are individually displayed in two-dimensional grid pattern. However, as the number of electronic images possessed by a user grows, the effort and time required to locate and view individual images also grows, often to an impractical extent.

The digital technology industry is experiencing advancements in content representation and management techniques such as multi-image aggregation, three-dimensional display, and collaborative content production. Some of these techniques may be applicable to certain aspects of managing voluminous archives of digital content objects.

U.S. Published Patent Application Nos. 2011/0016419 and 2011/0016406, both by Grosz et al., each disclose a multi-image aggregation solution implemented as a network-based collage editor. These patent applications support creation and editing of image and/or text-based content that is manually positioned onto a predefined geometric display window. Individual images in the collage, when highlighted, may be displayed with an associated text handle for identification and retrieval. Similarly, U.S. Pat. No. 7,576,755 to Jian Sun et al. discloses multi-image aggregation in the form of a picture collage system that displays digital images in related groups based on salient regions identified in each of multiple images. A two-dimensional display automatically presents a collage of overlapping images with blank spaces minimized, and places the images in a diversified rotational orientation to provide a natural artistic collage appearance. Although the collage systems above overcome some of the weaknesses of list or thumbnail views, the bounds of their two-dimensional displays and the overlapping of images inherent to collages both limit visibility of included images for navigation purposes.

Three-dimensional display of information is disclosed in U.S. Pat. No. 7,685,619 to Herz. More particularly, the Herz '619 patent discloses a system for displaying electronic program guide (EPG) and personal video recorder (PVR) information as a navigable three-dimensional structure. Similarly, computerized methods and systems for three-dimensional displaying and navigating search results are described in U.S. Published Patent Application No. 2012/0054622 by Nankani and are demonstrated in the Tag Galaxy website (www.taggalaxy.de). However, none of these display solutions support multi-user collaboration to facilitate addition of user-generated content to a three-dimensional navigation structure.

U.S. Pat. No. 7,143,357 to Snibbe et al. discloses structured collaborative digital media creation environments to enable communities of users to create full and partial digital media products. Similarly, U.S. Published Patent Application No. 2011/0016409 by Grosz et al. discloses a system for hosting multiple image product collaborators approved to contribute content and/or edits to content in an image and/or text-based project. However, neither of the Snibbe nor Grosz references discloses a three-dimensional navigation structure for organizing and presenting components of a collaboratively-developed digital media product.

There exists a need for a computerized product and process for grouping and displaying multiple digital content objects in a single graphic image so as to allow users to more easily and intuitively engage digital content, for example, on smart phones and tablets. Also, the computerized product and process should allow people to share and interact with groups of electronic content objects without having to transfer the individual digital content files. Furthermore, the computerized product and process should facilitate collaborative generation, contribution, and distribution of content for the new digital content objects grouping. Additionally, the computerized process should advantageously utilize the display capabilities of the display window so as to maximize the aesthetic qualities of digital content displayed thereon. These, and other features to enhance the use of smart phones when viewing large volumes of digital content are not present in the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are directed to a system and methods for representing, viewing, and sharing multiple digital content objects as a single graphical aggregation. The present invention may be configured to graphically combine multiple two-dimensional (2-D) digital images and related digital content objects into a single, three-dimensional (3-D) image that advantageously may deliver voluminous digital content within a space-limited display area. The 3-D image may be rotated to advantageously allow interaction with the various individual digital content objects that make up the 3-D aggregated image. The present invention advantageously may allow for the electronic exchange of the 3-D aggregated image amongst multiple users not only for shared viewing but also for collaborative editing of the 3-D aggregation without requiring transfer of the individual digital media files. The present invention also may advantageously allow for groupings of multiple electronic content objects to be stored, viewed, and shared in a way that may add dimensions of greater meaning and value not only to the user but also to the overall group of 3-D image production collaborators.

The digital content delivery system according to embodiments of the present invention may be configured as a computer program product that may include a data store, a digital image system, and a system interface. The data store may include digital content objects, each of which may be defined as a tile. The data store may be user-searchable, and the tiles may be user-selectable. The digital image system may be in data communication with the data store, and may include an aggregation subsystem, a delivery subsystem, and a collaboration subsystem. The system interface may be in data communication with the digital image system, and may control a 3-D display of the texture.

The aggregation subsystem may support retrieval of user-selected tiles, and receipt of user-selectable geometric output shape. The system interface may support keyword searching of the tiles included in the data store, and also user selection of tiles and of a geometric output shape. The aggregation subsystem may generate a rendering of each of the selected tiles. The aggregation subsystem may combine the renderings to form a texture, defined as a three-dimensional (3-D) object representation of the selected tiles having the specified geometric output shape. The geometric output shape may be specified as a cube, a sphere, a pyramid, an ellipsoid, or any other geometric shape. For any adjacent pair of renderings in the texture, perimeters of the pair of renderings may be substantially abutting. The aggregation subsystem may establish, for each rendering in the texture, an association to the tile from which the rendering is generated. In addition, the aggregation subsystem may establish, for any rendering in the texture, an association to selected tiles other than the tile from which the rendering is generated.

The aggregation subsystem may support editing of a texture by applying a change script to the texture. The change script may include change steps of selecting an alternative geometric output shape for the texture, repositioning renderings with respect to each other in the texture, removing renderings from the texture, and/or adding tiles to the texture. The aggregation subsystem may store the texture to the data store, and may set a single location identifier for the texture. Alternatively, or in addition, the aggregation subsystem may generate a 2-D object representation of the texture, may store the 2-D object representation to the data store, and may set a single location identifier for the 2-D object representation.

The delivery subsystem may generate a 3-D display of the texture. The 3-D display of the texture may be characterized by one set of renderings positioned on a viewable side of the selected geometric shape, another set of renderings positioned on an unviewable side of the selected geometric shape, and by one or more renderings displayed on the viewable side of the selected geometric shape in upright and face-on position. The delivery subsystem may rotate the 3-D display of the texture about a 3-D Cartesian coordinate system with respect to a geometric center of the texture. The delivery subsystem may manually rotate the 3-D display of the texture responsive to manipulation of a control input to the system interface. The control input may include swipe navigation, navigation controls, direction-control sliders, and/or pan navigation. The delivery subsystem may automatically rotate renderings in the 3-D display of the texture to present the front-most rendering(s) in an upright position. The delivery subsystem may receive a selection of a rendering in the texture, and may deliver tiles identified by associations for the selected rendering. The digital content delivery may be in a form of the associated tile(s) and/or a listing label.

The digital content delivery system may be configured as a computer program product that may include a first computing environment and a second computing environment, each computing environment having a data store, a digital image system, and a system interface as described above. The digital content delivery system may support sharing of textures between the first and second computing environments. The collaboration subsystem operating in the first computing environment may stage a copy of a first texture to a data store accessible from the second computing environment. The collaboration subsystem operating in the first computing environment may transmit an invitation to access the copy of the first texture from the second computing environment. Alternatively, or in addition, the collaboration subsystem operating at the first computing environment may generate a 2-D object representation of the copy of the first texture, and may send a message to the second computing environment containing the 2-D object representation of the copy of the first texture.

The delivery subsystem operating in the second computing environment may access and display the copy of the first texture. Additionally, the aggregation subsystem operating in the second computing environment may edit the copy of the first texture to create a second texture, and or may save and/or delete the copy of the first texture. The collaboration subsystem operating in the second computing environment may stage a copy of the second texture to a data store accessible from the first computing environment. The collaboration subsystem operating in the second computing environment may transmit an invitation to access the second texture from the first computing environment. The delivery subsystem operating in the first computing environment may access and display the copy of the second texture. The collaboration subsystem operating in the first computing environment may receive a delta object that may include cumulative edits applied to the copy of the first texture at the second computing environment to generate the second texture. The aggregation subsystem operating in the first computing environment may apply the delta object to change the first texture to match the second texture.

### BRIEF DESCRIPTION OF THE DRAWINGS

FIG. 1 is a schematic block diagram of a 3-D digital content delivery system according to an embodiment of the present invention.

FIG. 2A is a schematic block diagram of an exemplary data structure of a 3-D digital content delivery system according to an embodiment of the present invention.

FIG. 2B is a diagram illustrating an exemplary data structure of a 3-D digital content delivery system according to an embodiment of the present invention.

FIG. 3 is a flow chart illustrating a method of creating a 3-D aggregated digital image according to an embodiment of the present invention.

FIG. 4 is a flow chart illustrating a method of editing a 3-D aggregated digital image according to an embodiment of the present invention.

FIG. 5 is a diagram illustrating an exemplary system interface for 3-D digital image aggregation according to an embodiment of the present invention.

FIG. 6 is a flow chart illustrating a method of delivering digital content represented as a 3-D aggregated digital image according to an embodiment of the present invention.

FIG. 7A is a diagram illustrating an exemplary system interface showing a cube display of a 3-D aggregated digital image according to an embodiment of the present invention.

FIG. 7B is a diagram illustrating an exemplary system interface showing a sphere display of a 3-D aggregated digital image according to an embodiment of the present invention.

FIG. 8 is a flow chart illustrating a method of collaborating to generate a 3-D aggregated digital image according to an embodiment of the present invention.

FIGS. 9A, 9B, 9C, and 9D are diagrams illustrating an exemplary collaboration showing a changing of states of a 3-D aggregated digital image according to an embodiment of the present invention.

FIG. 10 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention. Like numbers refer to like elements throughout.

The terms “generally” and “substantially” may be used throughout the application. “Generally” may be understood to mean approximately, about, or otherwise similar in content or value. “Substantially” may be understood to mean mostly, more than not, or approximately greater than half. The meanings of these terms must be interpreted in light of the context in which they are used, with additional meanings being potentially discernible therefrom.

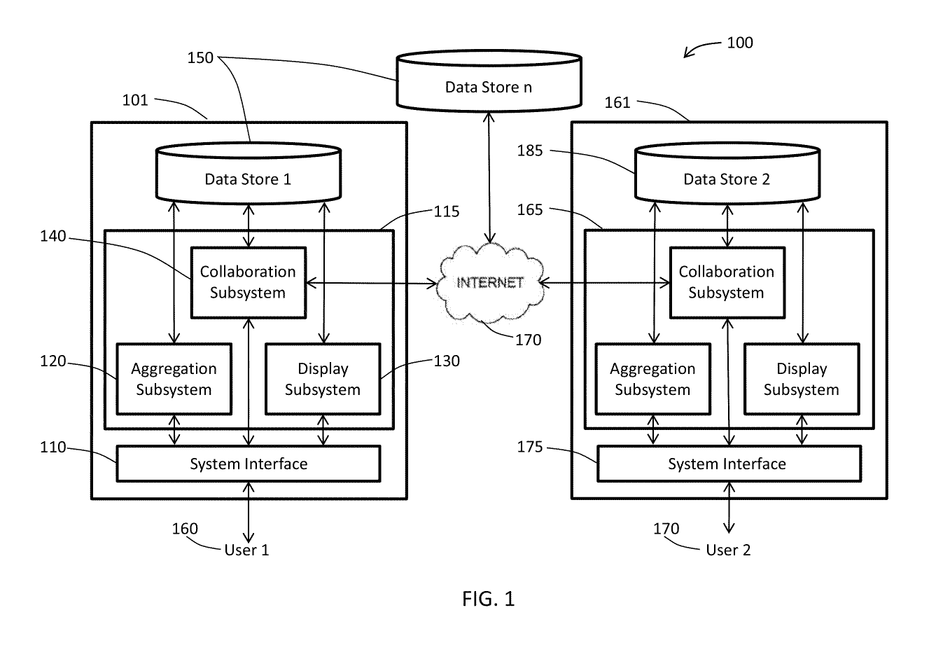

Referring now to FIGS. 1-10, a 3-D digital content delivery system 100 according to the present invention is now described in greater detail. Throughout this disclosure, the present invention may be referred to as a digital content delivery system 100, a digital image system, a computer program product, a computer program, a product, a system, a tool, and a method. Furthermore, the present invention may be referred to as relating to electronic photos, digital photographs, graphic images, and image files. Those skilled in the art will appreciate that this terminology does not affect the scope of the invention. For instance, the present invention may just as easily relate to scanned files, graphics files, text images, audio files, video files, or other digital media.

Example systems and methods for a digital content delivery system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

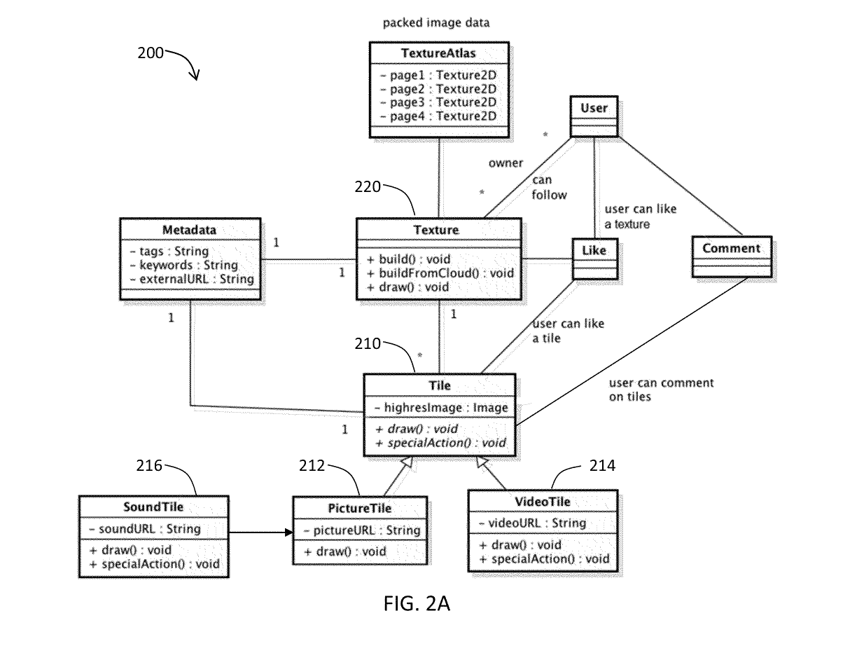

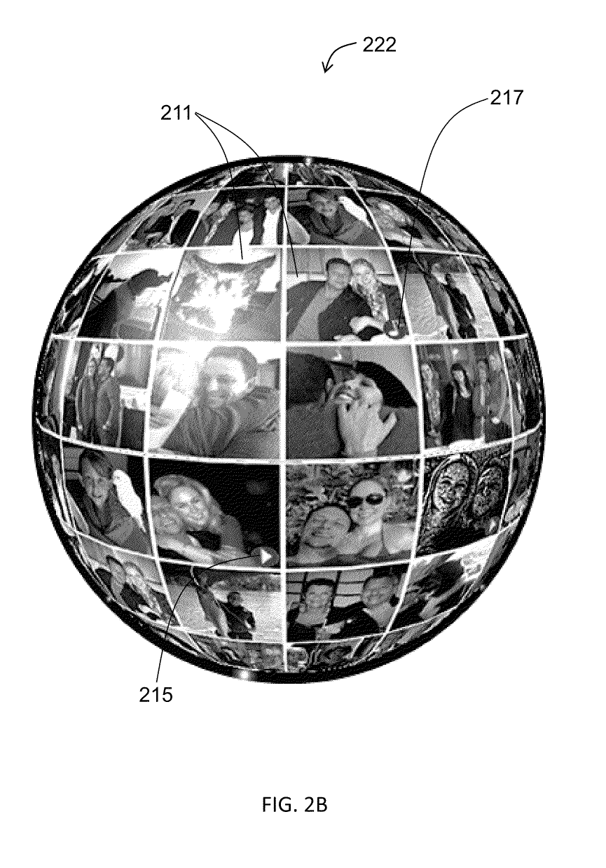

Referring now to FIGS. 1, 2A, and 2B, a digital content delivery system 100 configured to support 3-D representation, viewing, and sharing of digital content will now be discussed. For definition purposes, the term delivery as used herein refers to distribution and presentation of delivery of media content including, but not limited to, audio, video, picture, and text. Referring more specifically to FIG. 1, the digital content delivery system 100 of an embodiment of the present invention may include a system interface 110 that may communicate with a digital image system 115. The digital image system 115 may comprise an aggregation subsystem 120, a delivery subsystem 130, and a collaboration subsystem 140. A user 160 of the digital image system 100 may interact with the aggregation 120, display 130, and collaboration 140 subsystems using the system interface 110.

The aggregation subsystem 120 may be used to retrieve one or more digital content objects, each defined as a tile 210, from a data store 150. The aggregation subsystem 120 may be used to aggregate tiles 210 selected from the data store 150 into a single 3-D digital image, defined as a texture 220. The delivery subsystem 130 may be used to display the texture 220 as a 3-D navigable structure 222. The texture 220 may be stored to and retrieved from the data store 150. The collaboration subsystem 140 may be used to share the texture 220 among multiple users 160, 170 for collaborative production and editing of textures 220. Each of any number of additional users 170 may have access to her own computing environment 161 that may host a digital image system 165 (i.e., aggregation, display, and collaboration subsystems), system interface 175, and data store 185 to facilitate collaborative texture 220 generation and sharing. For example, and without limitation, separate computing environments 101, 161 each may comprise one or more of a computer, a tablet, and a smart phone, and may be in data communication with each other across a network 170. Alternatively, or in addition, separate computing environments 101, 161 each may comprise a hosted service, such as a social networking service. The data store 150 may include a plurality of databases stored on a single or multiple storage devices. For example, and without limitation, the data store 150 may comprise local storage, server-based storage, and/or cloud storage. Each of the types of storage listed may include attending computerized devices necessary for the utilization of the storage by the computing environments 101 and/or 161, including network interfaces, processors, storage media, and software necessary to accomplish said utilization.

The aggregation subsystem 120, the delivery subsystem 130 and the collaboration subsystem 140 will be described individually in greater detail below.

### Aggregation Subsystem

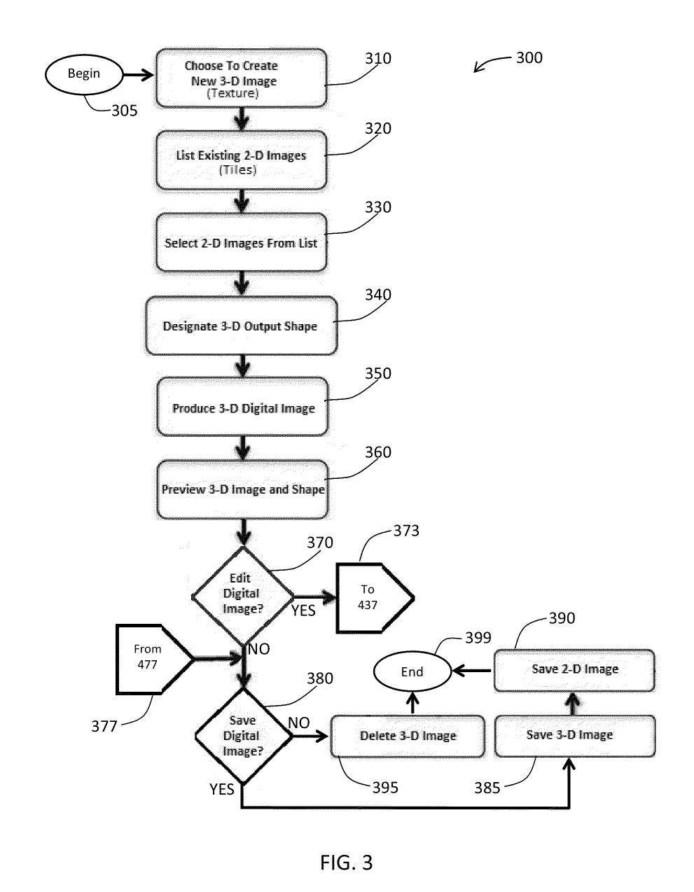

Referring now to FIG. 3, and continuing to refer to FIGS. 1, 2A and 2B, a method aspect 300 for aggregating digital content objects into a 3-D digital image representation will now be discussed. More specifically, the relationship between the system interface 110, the data store 150, and the aggregation subsystem 120 will now be discussed. The following illustrative embodiment is included to provide clarity for certain operational methods that may be included within the scope of the present invention. A person of skill in the art will appreciate additional databases and operations that may be included within the digital image system 100 of the present invention, which are intended to be included herein and without limitation.

Referring now more specifically to FIG. 3, the creation operation may begin at Block 310, where a user 160 may choose to create a new texture 220 by responding accordingly to a prompt from the system interface 110. The system interface 110 may direct the aggregation subsystem 120 to retrieve from the data store 150 a list of tiles 210 (Block 320), which the system interface 110 may present to the user 160 for selection (Block 330). For example, and without limitation, the system interface 110 may operate the aggregation subsystem 120 to support browser-based navigation of the data store 150. The tiles 210 may include 2-D digital image items 212 such as electronic photos, digital photographs, graphic images, image files, scanned files, text images, and drawn figures. It is contemplated and included within the scope of the invention that the 2-D digital image items 212 may themselves include a simulated 3-D element therein. In some embodiments, such included 3-D elements may be preserved by the creation operation. In some embodiments, such included 3-D elements may be transformed into a 2-D element so as not to inhibit the appearance of the 3-D presentation of the containing 2-D digital image item 212. Also, the tiles 210 may include multimedia items such as video 214, audio 216, and text files. The user may select tiles 210 from a pick list the tiles 210 desired for retrieval from the data store 150 and combination by the aggregation subsystem 120 into a single texture 220. At Block 340, the user 160 may designate one of multiple geometrical output shape options that the digital image system 100 may make available for 3-D presentation of the texture 220. Geometrical shape options may include, but are not limited to, a sphere, a cube, a pyramid, an ellipsoid, or any other geometric shape.

The aggregation subsystem 120 may generate a rendering 211 of each of the selected plurality of tiles 210. Each rendering 211 may be adorned with associations to selected tiles 210, including a primary association to the tile 210 from which the rendering is generated. Optionally, secondary associations to additional tiles 210 also may be selected by the user 160 to adorn any rendering 211. Such adornments may be displayed in conjunction with the host rendering 211. For example, and without limitation, an association to a video tile 214 may be represented as a “play” symbol 215 superimposed on the rendering 211. Also for example, and without limitation, an association to a sound tile 216 may be represented as a “musical note” symbol 217 superimposed on the rendering 211.

The renderings 211 may be shaped for positioning on the 3-D display structure 222 so as to be abutting, overlapping or slightly separated from each other. Additionally, each rendering 211 may be manipulated so as to permit the rendering to abut, overlap, or be separated as desired on the 3-D display structure 222. Types of manipulations may include, but are not limited to, scaling, cropping, adjusting the perspective ratio, keystoning, and the like. For example, and without limitation, the renderings 211 may be positioned on the 3-D display structure 222 so as to have no space between any pairing of contiguous renderings 211. Such seamless positioning of renderings 211 about the 3-D display structure 222 advantageously may make efficient use of limited-space displays, such as smart phone displays. The renderings 211 may be mapped over the geometric output shape designated by the user 160 such that renderings 211 may appear on one or more sides of the selected 3-D geometrical shape (Block 350). The aggregation system 120 may allow the user 160 to preview the resultant 3-D display structure 222 through the system interface 110 (Block 360).

After the user 160 previews a newly created 3-D display structure 222 as may be presented through the system interface 110, the user may opt not to edit the texture 220 any further (Block 370), and may instead elect to save the texture 220 (Block 380) by using the system interface 110 to direct the aggregation subsystem 120 to record the previewed texture 220 to the data store 150 (Block 385). At Block 390, the user 160 may also record the previewed texture 220 in 2-D form to the data store 150 so that a 2-D image may be made available for subsequent retrieval and viewing using computing environments that may not host the digital image system 100 or otherwise may not support 3-D display generally. Alternatively, the user 160 may elect to delete the newly created and previewed texture 220 (Block 395), which the user 160 may accomplish by using the system interface 110 to direct the aggregation subsystem 120 to not record the previewed texture 220 to the data store 150.

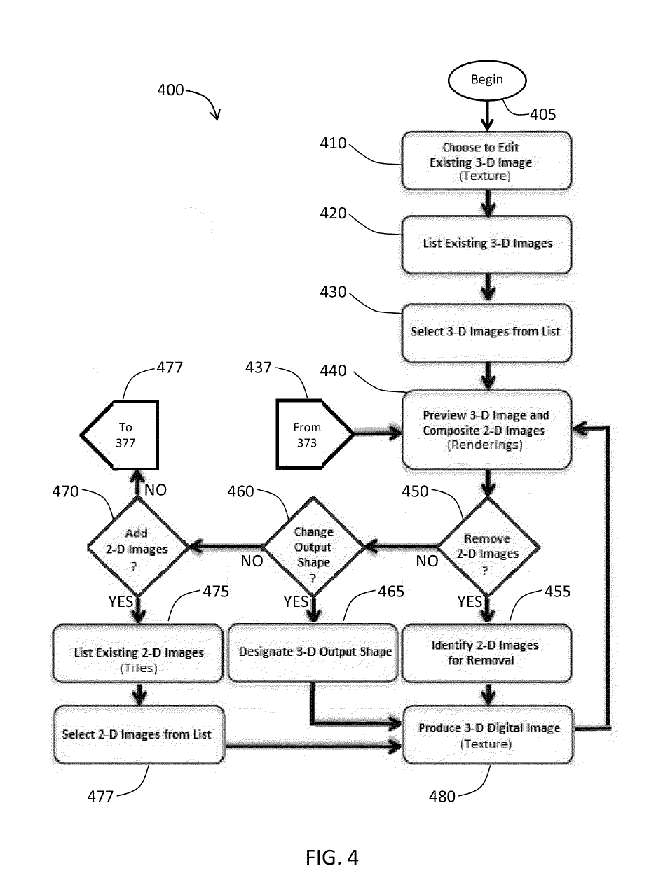

Referring now to FIG. 4, the edit operation of the aggregation subsystem 120 may begin at Block 410, where the user 160 may choose to edit an existing texture 220 by responding accordingly to a prompt from the system interface 110. Referring again to FIG. 3, if the user 110 decides to edit the texture 220 at Block 370, the operation that will be described with reference to the flow chart 400 of FIG. 4 is carried out. The system interface 110 may direct the aggregation subsystem 120 to retrieve from the data store 150 a texture 220 which the system interface 110 may present to the user 160 for selection (Block 420). The user 160 may select from the list of textures 220 retrieved from the data store 150 the desired texture 220 that may be presented by the aggregation subsystem 120 for editing (Block 430). At Block 440, the aggregation subsystem 120 may produce a preview of the texture 220 along with a list of composite tiles 210 from which the texture 220 may be formed.

After the user 160 previews the texture 220 as may be presented through the system interface 110, the user 160 may elect to remove renderings 211 from the texture 220 (Block 450) by using the system interface 110 to identify the rendering 211 to be removed by the aggregation subsystem 120 (Block 455). Alternatively, the user 160 may elect to change the type of geometrical output shape for the texture (Block 460) by using the system interface 110 to designate a new geometrical output shape for production of the 3-D navigable structure 222 by the delivery subsystem 140 (Block 465). Also, the user 160 may elect to add tiles 210 to the existing texture 220 (Block 470) by using the system interface 110 to direct the aggregation subsystem 120 to retrieve tiles 210 from the data store 150, which the system interface 110 may present to the user 160 for selection (Block 475). The user may select from the pick list of tiles 210 the desired tiles 210 retrieved from the data store 150 that may be added by the aggregation subsystem 120 into the existing texture 220 (Block 477). The aggregation subsystem may produce the edited texture 220 (Block 480), and the delivery subsystem 140 may allow the user 160 to preview the resultant 3-D navigable structure 222 through the system interface 110 (Block 440).

After the user 160 previews the 3-D navigable structure 222, the user 160 may employ the operations previously presented in FIG. 3 to elect to save (Blocks 385, 390) or to delete (Block 395) the edited texture 220 by using the system interface 110 to direct the aggregation subsystem 120 accordingly.

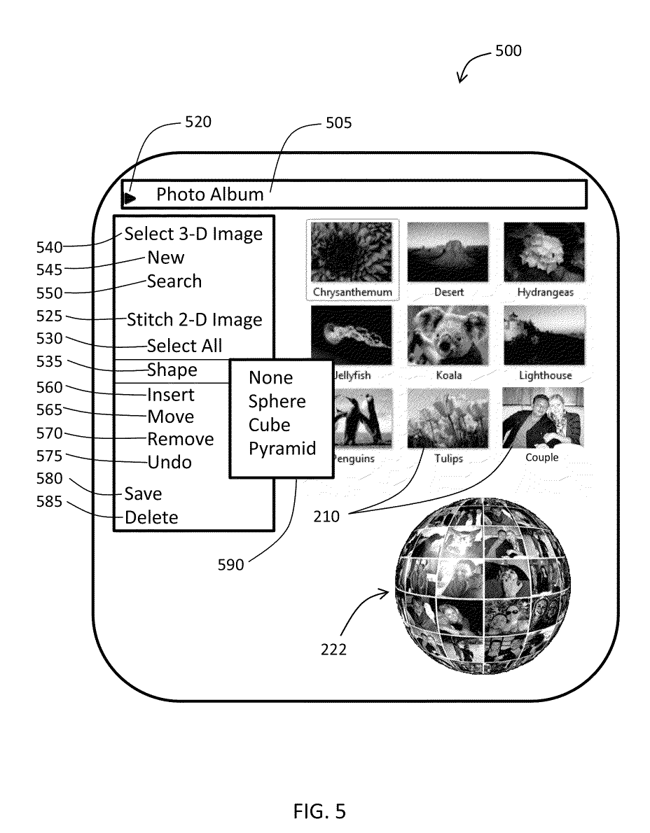

Referring now to FIG. 5, configuration of the system interface 110 to allow user interaction with the aggregation subsystem 120 of the present invention is described in detail. For example, and without limitation, the system interface 110 may include a plurality of interactive fields presented on a graphical user interface 500. However, a person of skill in the art will appreciate that interactive fields depicted in the graphical user interface 500 are provided solely as an example, and that any number of fields may be included in, or omitted from, the graphical user interface 500 of the present example.

The exemplary graphical user interface 500 depicted in FIG. 5 illustrates a model interface for operation of the aggregation subsystem 120 in communication with the data store 150. The graphical user interface 500 may include a plurality of fields which may allow for interaction by the user 160. For example, and without limitation, a Photo Album field 505 may be included in the graphical user interface 500 that may define the storage location of both tiles 210 and/or 3-D navigable structures 222 upon which the digital image system 100 may operate. Multiple Photo Albums may be available to the user 160 via the Photo Album field 505 of the system interface 110. To locate a particular Photo Album by using directory tree navigation, a user 160 may active a Browse operator 520. The user 160 may then navigate a directory tree structure similar to the file browsing mechanism found in common operating systems.

For example, and without limitation, the user 160 may active the Stitch 2-D Image fields 525 to initiate creation of new textures 220 within a Photo Album. Upon opening of any particular Photo Album, the system interface 110 may present the user 160 with a list of filenames for tiles 210 that the user 160 may select for inclusion in a new texture 220. Alternatively, or in addition, the tiles 210 in a Photo Album may be presented by the system interface 110 as thumbnail images. To identify the tiles 210 for inclusion in the texture 220, the user 160 may select a subset of the available tiles 210 using, for example, and without limitation, point-and-click selection of individual tiles 210. Alternatively, the user 160 may active the Select All 530 field to identify all of the tiles 210 available in the Photo Album for aggregation into the texture 220. The user 160 may choose the Shape field 535 under Stitch 2-D Image fields 525 to designate a desired 3-D geometric shape for a new texture 220. For example, and without limitation, the 3-D geometrical output shapes 590 supported by the digital image system 100 may include a sphere, a cube, a pyramid, and an ellipsoid.

Continuing to refer to FIG. 5, the user 160 may select the New field 545 under Select 3-D Image 540 to initiate production by the aggregation subsystem 120 of a texture 220 from the tiles 210 specified by the user 160. The user 160 may active the Save field 580 to record the resultant texture 220 into a Photo Album. Alternatively, the user 160 may elect not to save the new texture 220 by choosing the Delete field 585.

For example, and without limitation, the user 160 may use the Stitch 2-D Image fields 525 to initiate editing of an existing texture 220 within a Photo Album. Upon navigation to any particular Photo Album, the system interface 110 may present the user 160 with a 2-D representation of a texture 220 previously saved to the Photo Album which he may select for editing, for example, and without limitation, using point-and-click selection. Alternatively, the user 160 may active the Search field 550 under Select 3-D Image 540 to perform, for example, a keyword search by filename of all the tiles 210 available in the identified Photo Album.

Continuing to refer to FIG. 5, the user 160 may select any of the editing fields under Stitch 2-D Image 525 to alter the digital content object 210 included in the retrieved texture 220. For example, and without limitation, the user 160 may active the Insert field 560 to add a selected tile 210 to the texture 220 being edited. Similarly for example, and without limitation, the user 160 may active the Remove field 570 to delete a tile 210 from the texture 220 being edited. Also, the user 160 may use the Move field 565 to alter the circumferential position of a selected tile 210 on the viewing surface of the texture 220 being edited. As described above, the user 160 may choose the Shape field 535 under Stitch 2-D Image 525 to designate a different geometric output shape for a texture 220 being edited. The user 160 may use the Undo field 575 to reverse the previous series of changes made to the texture 220 being edited using the Insert 560, Move 565, Remove 570, and/or Shape 535 fields.

### Delivery Subsystem

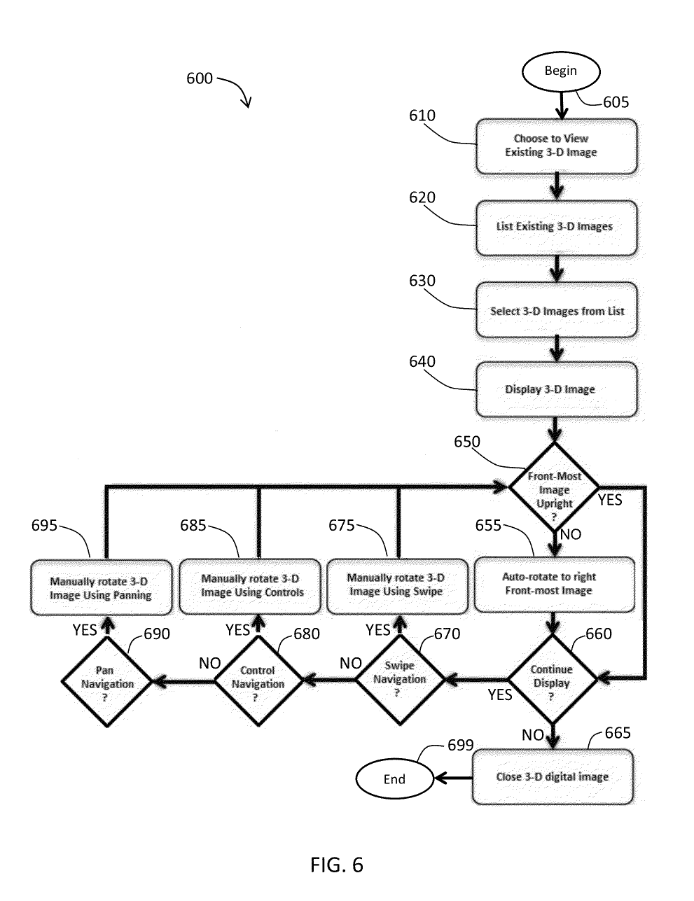

Referring now to FIG. 6, and continuing to refer to FIGS. 1, 2A and 2B, a method aspect 600 for delivering digital content objects within a 3-D digital image representation will now be discussed. More specifically, the relationship between the system interface 110, the data store 150, and the delivery subsystem 130 will now be discussed. The following illustrative embodiment is included to provide clarity for one operational method that may be included within the scope of the present invention. A person of skill in the art will appreciate additional databases and operations that may be included within the digital image system 100 of the present invention, which are intended to be included herein and without limitation.

Referring now to FIG. 6, the operation may begin at Block 610, where a user 160 may choose to view an existing texture 220 represented as a 3-D navigable structure 222 by responding accordingly to a prompt from the system interface 110. The system interface 110 may direct the delivery subsystem 130 to retrieve from the data store 150 a list of textures 220 (Block 620), which the system interface 110 may present to the user 160 for selection (Block 630). The user 160 may select from the list of textures 220 the desired texture 220 retrieved from the data store 150. At Block 640, the delivery subsystem 130 may produce the 3-D navigable structure 222 for viewing through the system interface 110. The one or more sides, when referring to a 3-D navigable structure 222, may be defined with reference to a viewer. For example, and without limitation, the 3-D navigable structure 222 may have a viewable side (e.g., a front side) and a side that is not viewable by the viewer (e.g., a back side). Upon initial display after retrieval from the data store 150, a sphere-shaped 3-D navigable structure 222 may be oriented for viewing by the user 160 such that the front-most single rendering 211 in the 3-D navigable structure 222 is displayed in an upright position (Blocks 650, 655). For purposes of definition, the front-most rendering 211 may be considered the rendering that is “closest” to a display of the system interface 110 viewable by the user 160. More specifically, the front-most rendering 211 may be the rendering that is positioned on a portion of a surface of the 3-D navigable structure 222 that is simulated as being nearest a surface defined by the display of the system interface 110. Alternatively, a cube-shaped 3-D navigable structure 222 may be oriented for viewing by the user 160 such that a plurality of renderings 211 may simultaneously be front-most and, therefore, displayed in an upright position. The user 160 may opt to view a retrieved 3-D navigable structure 222 with the composite renderings 211 presented to scale or with the front-most rendering 211 modified to appear larger in order to facilitate ease of viewing.

Continuing to refer to FIG. 6, the user 160 may elect to terminate a display session through the system interface 110 by closing the 3-D navigable structure (Blocks 660, 665). Alternatively, the user 160 may choose to manually navigate through the renderings 211 of the 3-D navigable structure 222 by using the system interface 110 to direct the delivery subsystem 130 to rotate the 3-D navigable structure 222. For example, and without limitation, if the digital image system 100 supports swipe navigation (Block 670), the user 160 may swipe the 3-D structure 22 on the display to cause rotation of the 3-D structure 222 in the direction of and at the speed of the swipe (Block 675). Similarly, if the digital image system 100 supports navigation controls (Block 680), the user 160 may manipulate direction-control sliders on the display to cause rotation of the 3-D structure 222 (Block 685). Also, if the digital image system 100 supports pan navigation (Block 690), the user 160 may click and drag a cursor to cause rotation of the 3-D structure (Block 695). If, after a manual rotation of the 3-D structure 222, the front-most single rendering 211 in the 3-D navigable structure 222 is displayed in an other than upright position, the delivery subsystem 130 may automatically rotate the 3-D structure 222 to present the front-most rendering 211 in an upright position (Blocks 650, 655).

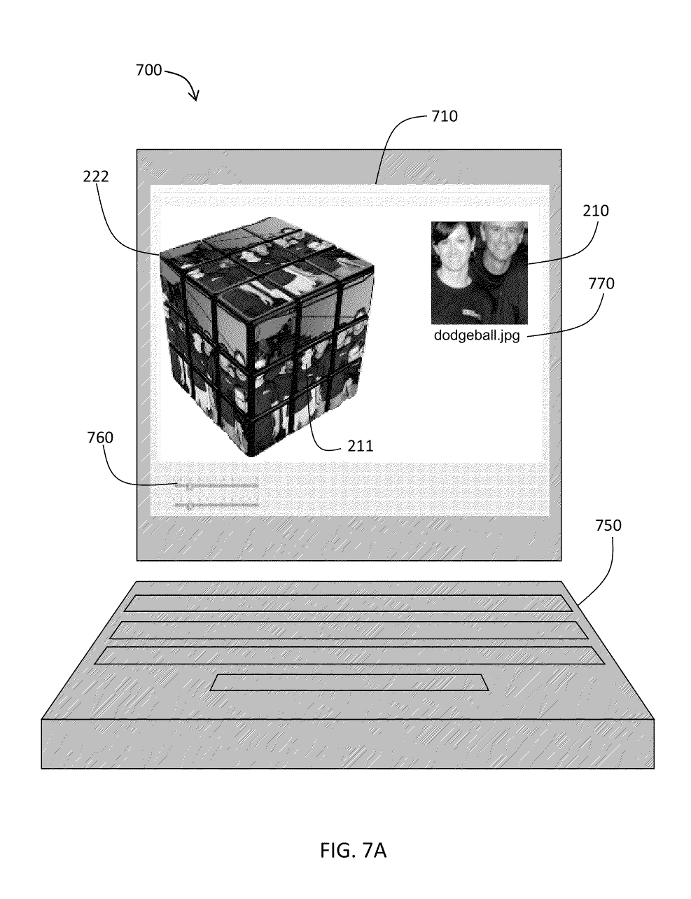

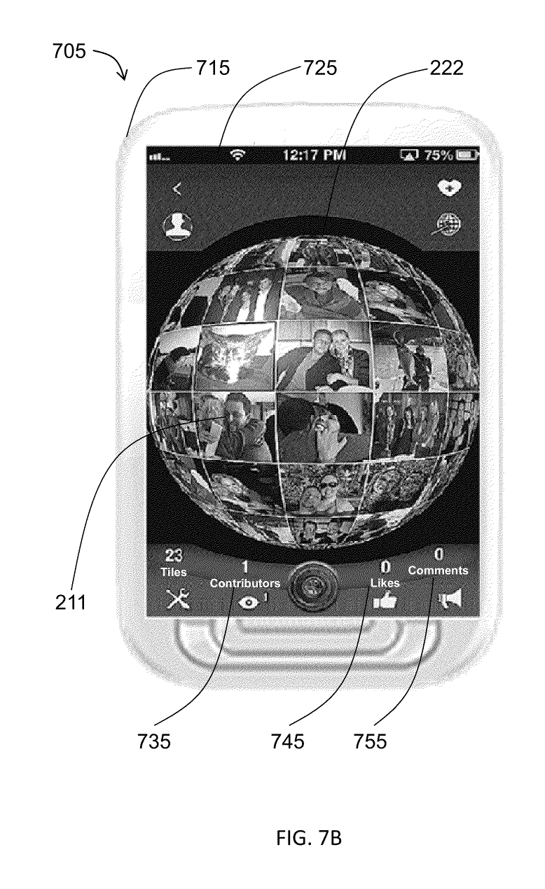

Referring now to FIGS. 7A and 7B, configuration of the system interface 110 to allow user interaction with the delivery subsystem 130 of the present invention is described in detail. For example, and without limitation, the system interface 110 may present a 3-D navigable structure 222 on a display. However, a person of skill in the art will appreciate that the devices illustrated in FIGS. 7A and 7B are for example, and without limitation, and that alternative display-capable automated devices may be applicable, including without limitation, tablets, touch pads, holographic displays, projection displays, and enhanced reality optical displays.

The graphics-capable device 700 depicted in FIG. 7A illustrates an exemplary interface for operation of the delivery subsystem 130 in communication with the data store 150. The device 700 may include computer monitor 710 that may present a 3-D navigable structure 222 which may be interacted by the user 160 using an input device such as a keyboard 750, mouse, or joystick. The user 160 may direct the system interface 110 to command the delivery subsystem 130 to rotate the 3-D structure 222 in a user-specified direction with respect to a three dimensional Cartesian coordinate system. Upon opening or after rotating of a 3-D structure 222, the delivery subsystem 130 may automatically rotate the entire 3-D structure 222 if necessary to return to an upright position the front-most rendering 211 displayed via the system interface 110. The user 160 also may use the system interface 110 to cause the delivery subsystem 130 to de-aggregate a rendering 211 to allow 2-D viewing of individual or multiple tiles 210 that may be included in the texture 210 from which the 3-D structure 222 is generated. For example, and without limitation, the user 160 may identify a tile 210 for individual 2-D viewing by clicking on the rendering 211 to which that tile 210 may be associated, which may result in a detailed description 770 of the selected tile 210 to be shown on a separate page or on the same page where the 3-D navigable structure 222 may be displayed.

For example, and without limitation, the delivery subsystem 130 may respond to a viewing request by a user 160 by presenting a cube-shaped 3-D navigable structure 222 that may be displayed via the system interface 110 executing on laptop computer 700. The delivery subsystem 130 may, upon opening of the cube-shaped 3-D structure 222 for viewing, cause the orientation of a plurality of front-most 2-D images 212 displayed on the cube to be upright. The system interface 110 may include navigation control sliders 760 positioned proximate to the 3-D structure 222 that may allow a user 160 to control the speed and direction of rotation of the cube 222 and, consequently, may permit the user 160 to navigate to any rendering 211 located on any side of the 3-D structure 222. The delivery subsystem 130 may respond to the user 160 identification of individual renderings 211 for detailed viewing by presenting via the system interface 110 representations (e.g., image 210, thumbnail, and/or listing label 770) of one or more tile 210 associated with the rendering 211. For example, and without limitation, the listing label 770 may comprise a title and/or a detailed description of the tile 210. The detailed description may include a description of the tile 210, the contributing user, and one or more dates relating to the tile 210. The dates may include a creation date and/or an aggregation addition date.

The graphics-capable device 705 depicted in FIG. 7B illustrates an alternative model interface for operation of the delivery subsystem 130 in communication with the data store 150. The device 705 may include a smart phone 715 having a touch screen 725 that may present a 3-D navigable structure 222 which may be interacted by the user 160. As described above, the delivery subsystem 130 may support manual rotation of the 3-D structure 222 with respect to a three dimensional Cartesian coordinate system, auto-rotation of the 3-D structure 222 to right the front-most tile 210, and 2-D viewing of individual tiles 210 associated with renderings 211 included in the 3-D structure 222.

For example, and without limitation, the delivery subsystem 130 may respond to a viewing request by a user 160 by presenting a sphere-shaped 3-D navigable structure 222 that may be displayed via the system interface 110 executing on a smart phone 715. Upon opening of the sphere-shaped 3-D structure 222 for viewing, the delivery subsystem 130 may cause the orientation of the front-most 2-D image 210 displayed on the sphere 222 to be upright. The system interface 110 may support swipe commands to allow a user 160 to control rotation and orientation of the sphere of digital images 222 and, consequently, may permit the user 160 to navigate to any rendering 211 located on any side of the 3-D structure 222. The delivery subsystem 130 may respond to user 160 identifying individual renderings 211 for detailed viewing by presenting via the system interface 110 a representation of the one or more tiles 210 (e.g., image, thumbnail, and/or listing label) to which the rendering 211 may be associated. A user 160 may save the rendering 211 and or associated tiles 210 to a data store 150 if desired.

### Collaboration Subsystem

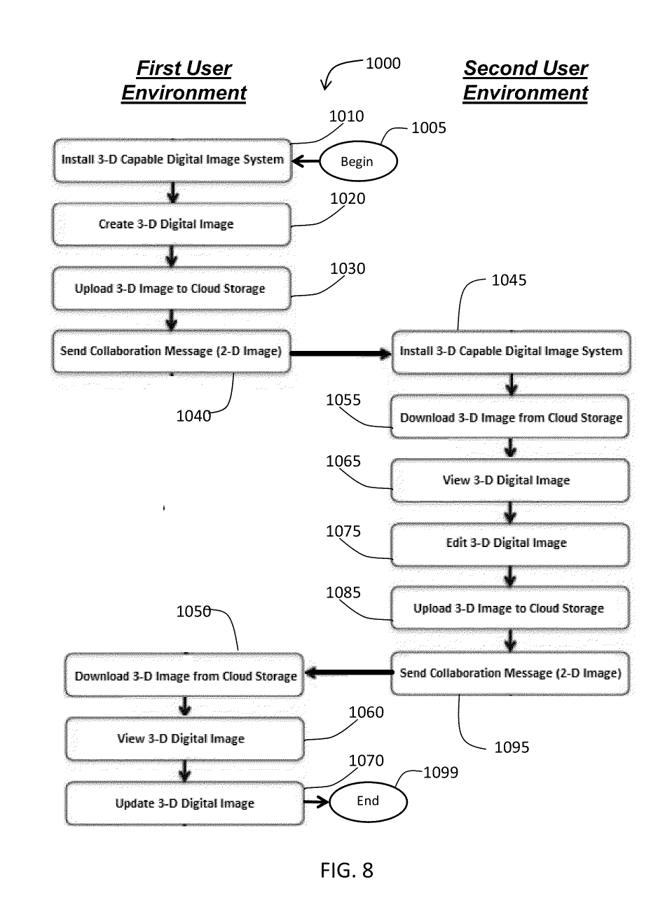

Referring now to FIG. 8, and continuing to refer to FIGS. 1, 2A and 2B, a method aspect 1000 for collaborative generation of a texture 220 will now be discussed. More specifically, the relationship between the system interface 110, the data store 150, and the collaboration subsystem 140 will now be discussed. The following illustrative embodiment is included to provide clarity for one operational method that may be included within the scope of the present invention. A person of skill in the art will appreciate additional databases and operations that may be included within the digital image system 100 of the present invention, which are intended to be included herein and without limitation.

Continuing to refer to FIG. 8, the operation may begin at Block 1010, where a user 160 may install the digital image system 100 on a desired computing device 101, 161. The user 160 may, using the system interface 110, operate the aggregation subsystem 120 to create a texture 220 (Block 1020) as a baseline for collaborative production of the texture 220. At Block 1030, the user 160 may employ the collaboration subsystem 140 to upload the baseline texture 220 to a data store 150, 185 accessible by prospective collaborators. For example, and without limitation, the shared data store 150 may be a cloud storage service, as will be readily understood by those skilled in the art. The user 160 may use the collaboration subsystem 140 to send a message to one or more prospective collaborators, inviting the collaborator(s) to participate in shared viewing and/or joint production of the texture 220 (Block 1040). The message may contain a 2-D, low-resolution version of the texture in case the invited collaborator does not have a computing device 161 configured with 3-D viewing capability.

Continuing to refer to FIG. 8, a second user 170 may install the digital image system 100 with 3-D image viewing and editing capability onto a second computing device 161 (Block 1010). At Block 1050, the second user 170 may employ the collaboration subsystem 140 installed on the second computing device 161 to access the texture 220 shared by the first user 160 from a mutually-accessible data store 150, 185, such as a cloud storage service. Access to the data store 150, 185 may be controlled by permission systems, such as user id/password access confirmation. The second user 160 may view the shared texture 220 (Block 1060) by responding accordingly to a prompt from the system interface 110. The user 170 may choose to navigate through the composite renderings 211 of the texture 220 by using the system interface 110 to direct the delivery subsystem 130 to manually rotate the 3-D navigable structure 222 as described above. At Block 1070, the user 160 may elect to edit the texture 220 by removing renderings 211 and associations to tiles 210 from the texture 220 (Block 350 from FIG. 3), by designating a new geometrical output shape for the texture 220 (Block 365 from FIG. 3), and/or by adding tiles 210 to the shared texture 220 (Block 375 from FIG. 3). The second user 170 may employ the collaboration subsystem 140 to stage the edited texture 220 to a data store 150 accessible by the originating user 160 (Block 1080), and to send a message inviting the first user 160 to view and/or edit the edited texture 220 (Block 1040). Staging may be defined as the temporary storage of the edited texture 220 to the data store 150 prior to the access of the edited texture 220 by the first user 160. The edited texture 220 may be staged on the data store 150 until accessed by the first user 160, whereupon the staged version of the edited texture 220 may be deleted. In some embodiments, the staged edited texture 220 may be preserved on the data store 150 after access and editing by the first user 160 so as to provide a version history of the edited texture 220. The first user 160 may employ the collaboration subsystem 140 to access the edited texture 220 (Block 1050) shared by the second user 170, and to view the cumulative edits to the original texture 220 (Block 1060). At Block 1090, the user 160 may respond to a prompt from the system interface 110 to direct the collaboration subsystem 140 to update the original copy of the texture 220 with the edits present in the edited copy of the texture 220 shared by the second user 170. The user 160 may employ the operations previously presented in FIG. 2 to elect to save (Blocks 280, 285, 290) or to delete (Block 295) the edited texture 220 by using the system interface 110 to direct the aggregation subsystem 120 accordingly.

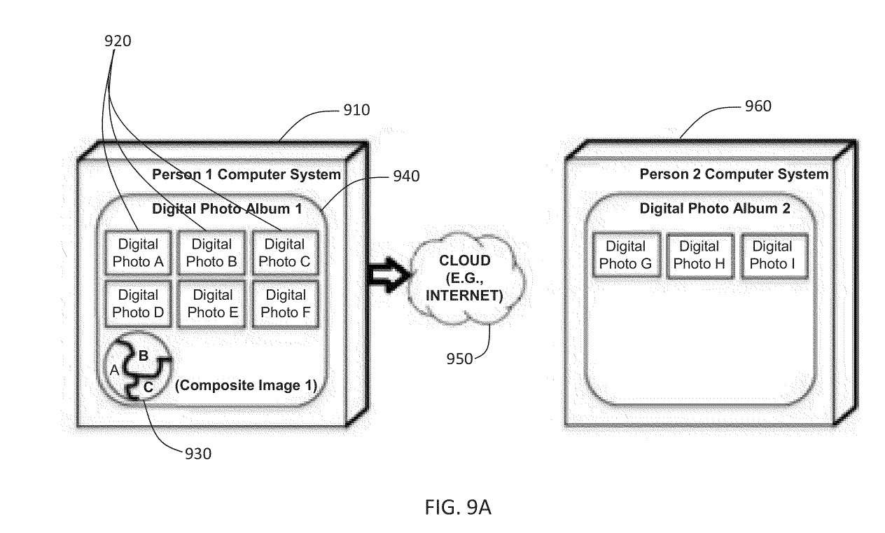

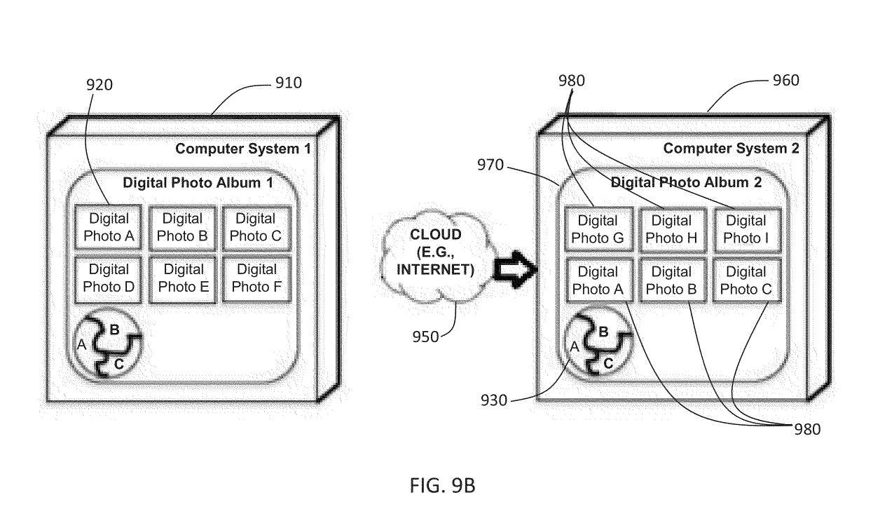

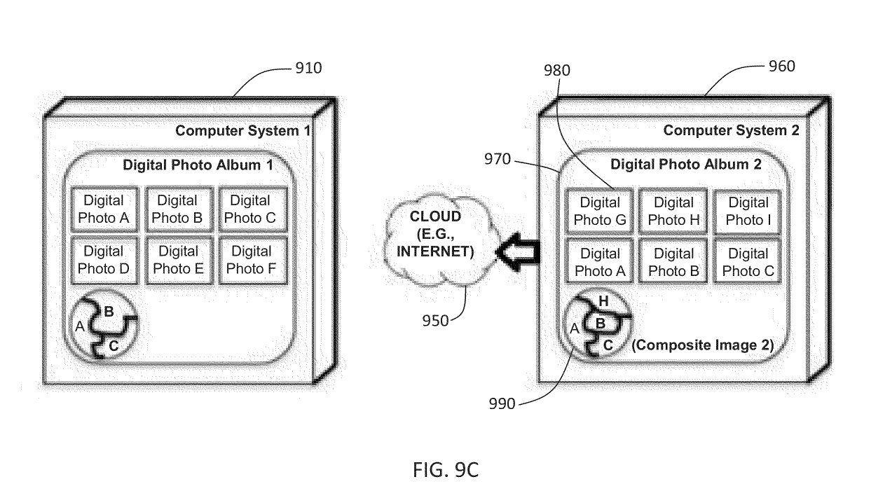

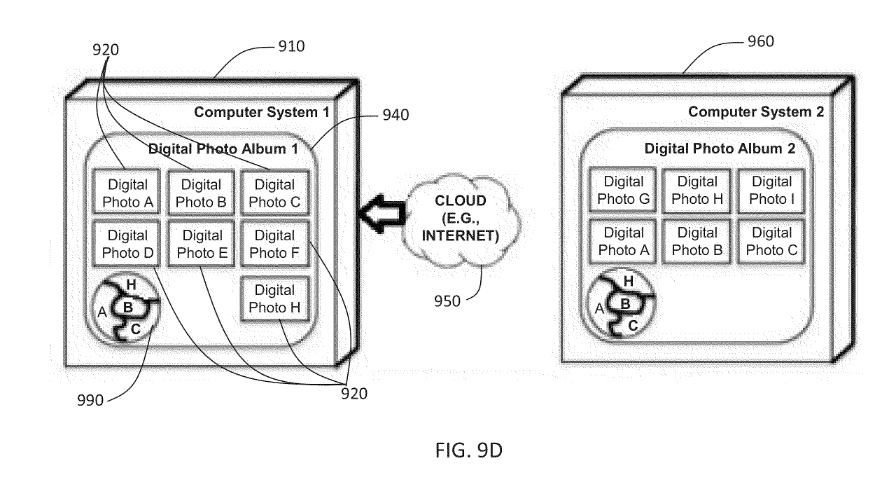

Referring now to FIG. 9A, the digital image system 100 may be installed on a first computing device 910. For example, and without limitation, the first user 160 may use the system interface 110 to cause the delivery subsystem 130 to present a listing of tiles 920 and textures 930 as presented in Photo Album 1 at 940. In this example, Digital Photos A, B, and C at 920 may appear in Photo Album 1 at 940 not only as individual tiles 920, but also as aggregated images stitched together to form a texture Composite Image 1 at 930. The first user 160 may stage Composite Image 1 at 930 to a shared, e.g., cloud-based, data store 950, and may invite the second user 170 to participate in collaborative production of a new texture using Composite Image 1 at 930 as a baseline from which to begin.

Referring now to FIG. 9B, the digital image system 100 may be installed on a second computing device 960. For example, and without limitation, the second user 170 may use the collaboration subsystem 140 to access texture Composite Image 1 at 930 from the shared data store 950 and to store a copy of that texture 930 to Photo Album 2 at 970. The second user 170 may use the system interface 110 to cause the delivery subsystem 130 to present a listing of tiles 980 and also the copy of texture Composite Image 1 930 as presented in Photo Album 2 at 970. In this example, accessing of the copy of texture Composite Image 1 930 also may cause Digital Photos A, B, and C at 980 to be disaggregated from Composite Image 1 at 930 and to appear in Photo Album 2 at 970 as individual tiles 980.

Referring now to FIG. 9C, the second user 170 may use the system interface 110 to cause the delivery subsystem 130 to present a listing of tiles and textures as presented in Photo Album 2 at 970. In this example, Digital Photo H at 980 may appear in Photo Album 2 at 970 not only as a tile 980, but also as an addition to 3-D digital image Composite Image 1 to create a Composite Image 2 at 990. The second user 170 may upload Composite Image 2 at 990 to a shared (perhaps cloud-based) data store 950, and may invite the first user 160 to continue in collaborative production of a 3-D digital image, now using Composite Image 2 at 990 as a draft from which to continue editing.

Referring now to FIG. 9D, the first user 160 may use the collaboration subsystem 140 to access Composite Image 2 at 990 from the shared data store 950 and to store a copy of that texture 990 to Photo Album 1 at 940. The first user 160 may use the system interface 110 to cause the delivery subsystem 130 to present a listing of tiles 920 and also the copy of Composite Image 2 at 990 as presented in Photo Album 1 at 940. In this example, downloading of Composite Image 2 at 990 in its aggregate form also may cause Digital Photo H 920 to be disaggregated from Composite Image 2 at 990 and to appear in Photo Album 1 at 940 as an individual tile 920.

Continuing to refer to FIGS. 8, 9A, 9B, 9C, and 9D, the same method steps and state changes that characterize collaborative development of textures may also support social networking based on digital content. Referring again to FIGS. 7B and 8, for example, and without limitation, special operators may be supported by the system interface 110 to facilitate a social networking embodiment of the collaboration subsystem 140. Contributors to a collaboratively developed texture 220 may be tracked using a Contributors operator 735. Also for example, and without limitation, a Likes operator 745 and/or a Comments operator 755 may be used to associate renderings with content tiles that may contain collaborator feedback regarding the subject texture 220.

### Computing Environment

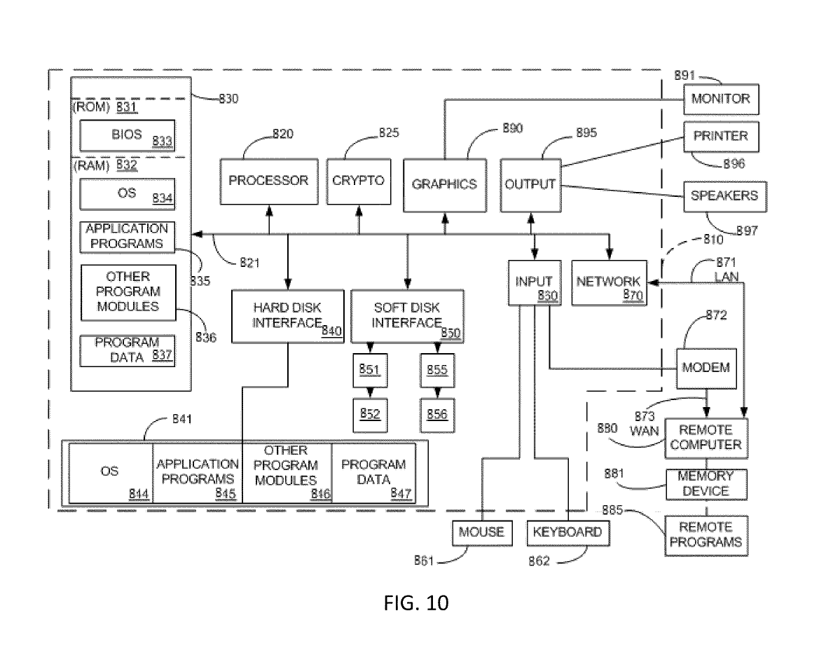

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 10 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates an operating system (OS) 834, application programs 835, other program modules 836, and program data 837.

The computer 810 may also include other removable/non-removable, volatile/nonvolatile computer storage media. By way of example only, FIG. 13 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 13, provide storage of computer readable instructions, data structures, program modules and other data for the computer 810. In FIG. 13, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 13. The logical connections depicted in FIG. 13 include a local area network (LAN) 871 and a wide area network (WAN) 873, but may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Many modifications and other embodiments of the invention will come to the mind of one skilled in the art having the benefit of the teachings presented in the foregoing descriptions and the associated drawings. The scope of the invention should be determined by the appended claims and their legal equivalents, and not by the examples given Therefore, it is understood that the invention is not to be limited to the specific embodiments disclosed.

What is claimed is:

1. A computer program product embodied in a computer-readable storage medium for delivering digital content comprising:
a data store that includes a plurality of digital content objects, each of the plurality of digital content objects defined as a tile;
a digital image system in data communication with the data store and configured to
retrieve a subset of the plurality of tiles, the subset collectively defined as selected tiles,
receive a geometric output shape,
generate a respective rendering of each of the selected tiles, wherein each rendering has a perimeter, and
combine the plurality of renderings to form a texture defined as a three-dimensional (3-D) object representation of the selected tiles having the geometric output shape, wherein the respective perimeters of any adjacent pair of the plurality of renderings in the texture are substantially abutting; and
a system interface in data communication with the digital image system and configured to control a 3-D display of the texture.

2. A computer program product according to claim 1 wherein the data store is searchable; and wherein the system interface is configured to support keyword searching of the plurality of tiles included in the data store.

3. A computer program product according to claim 1 wherein the selected tiles are user-selectable; and wherein the digital image system is further configured to
establish, for each respective rendering, an association to a respective at least one tile included in the selected tiles, the association including an association to the respective tile from which the each respective rendering is generated, defined as a primary association.

4. A computer program product according to claim 3 wherein the geometric output shape is user-selectable and is of a type selected from the group consisting of a cube, a sphere, a pyramid, and an ellipsoid.

5. A computer program product according to claim 3 wherein the digital image system is further configured to
store the texture to the data store, and
set a single location identifier for the texture.

6. A computer program product according to claim 3 wherein the digital image system is further configured to
generate a two-dimensional (2-D) object representation of the texture,
store the 2-D object representation to the data store, and
set a single location identifier for the 2-D object representation.

7. A computer program product according to claim 3 wherein the digital image system is further configured to
generate a 3-D display of the texture using the system interface,
rotate the 3-D display of the texture about a 3-D Cartesian coordinate system with respect to a geometric center of the texture, and
deliver, responsive to selection of any respective rendering in the texture, defined as a selected rendering, the tile identified by the primary association for the selected rendering.

8. A computer program product according to claim 7 wherein delivery of the tile, upon selection of a respective rendering, may be in a form of at least one of the tile and a listing label, the listing label selected from the group consisting of title, detailed description, description of the image, contributing user, creation date, and texture addition date.

9. A computer program product according to claim 7 wherein the digital image system is further configured to rotate the 3-D display of the texture responsive to manual manipulation of a control input from the system interface, the control input being of a type selected from the group consisting of swipe navigation, navigation controls, direction-control sliders, and pan navigation.

10. A computer program product according to claim 9 wherein the digital image system is further configured to automatically rotate a front-most at least one rendering in the 3-D display of the texture to present the front-most at least one rendering in an upright position responsive to the manual manipulation of the control input from the system interface.

11. A computer program product according to claim 7 wherein the digital image system is further configured to establish a secondary association with at least one of the plurality of renderings in the texture, each secondary association being defined as an association with a respective one of the selected tiles and as different than the primary association; and wherein the digital image system is further configured to deliver, responsive to selection of the at least one of the plurality of renderings in the texture, the tile associated with each secondary association.

12. A computer program product according to claim 7 wherein the digital image system is further configured to
send, using a first computing environment, a copy of the texture, defined as a first texture, to a data store accessible from a second computing environment,
transmit, using the first computing environment, an invitation to access the first texture from the second computing environment,
receive, using the first computing environment, a second texture sent from the second computing environment, and
display the second texture using the first computing environment.

13. A method of using a computer program product embodied in a computer-readable storage medium for delivering digital content, the computer program product comprising a data store, a digital image system in data communication with the data store, and a system interface in data communication with the digital image system; the method comprising:
accessing the data store that includes a plurality of digital content objects, each of the plurality of digital content objects defined as a tile;
selecting a subset of the plurality of tiles, the subset defined as selected tiles;
selecting a first geometric output shape;
generating a respective rendering of each of the selected tiles, wherein each rendering has a perimeter;
combining the plurality of renderings to form a texture, defined as a three-dimensional (3-D) object representation of the selected tiles having the first geometric output shape, wherein the respective perimeters of any adjacent pair of the respective renderings in the texture are substantially abutting; and
controlling a 3-D display of the texture.

14. A method according to claim 13 wherein accessing the data store comprises displaying, using the system interface, an identifier for each of the plurality of tiles, wherein the identifier for each of the plurality of tiles is displayed as a member of a tile pick list of a type selected from the group consisting of a list of tile filenames and a folder of two-dimensional (2-D) icons.

15. A method according to claim 13 wherein controlling the 3-D display of the texture comprises generating the 3-D display of the texture using the interface, the 3-D display of the texture characterized by a front subset of the respective renderings positioned on a viewable side of the first geometric shape, by a back subset of the respective renderings positioned on an unviewable side of the first geometric shape, and by at least one front-most rendering included in the front subset and displayed in upright and face-on position.

16. A method according to claim 15 further comprising rotating the 3-D display of the texture about a 3-D Cartesian coordinate system with respect to a geometric center of the texture.

17. A method according to claim 15 further comprising
creating an edited texture by applying a change script to change the texture, wherein the respective perimeters of renderings adjacently-positioned in the edited texture are substantially abutting; and
generating a 3-D display of the edited texture using the system interface, the 3-D display of the edited texture characterized by
a second front subset of the respective renderings positioned on a viewable side of the second geometric shape,
a second back subset of the respective renderings positioned on an unviewable side of the second geometric shape, and
a second at least one front-most respective rendering included in the front subset and displayed in upright and face-on position;
wherein editing the texture comprises at least one step selected from the group consisting of
selecting a second geometric output shape and recording the second geometrical output shape selection to the change script,
repositioning at least one of the respective renderings with respect to at least one other of the respective renderings forming the texture and recording the repositioning to the change script,
removing at least one of the respective renderings from the texture and recording the removal to the change script, and
selecting an additional tile included in the plurality of tiles, but not included in the selected tiles, and generating a rendering of the additional tile that has a perimeter and recording the additional tile selection in the change script.

18. A method according to claim 13 further comprising at least one step selected from the group consisting of
saving the texture to the data store, the texture defining a saved texture; and
deleting the saved texture from the data store.

19. A method according to claim 18 wherein saving the texture further comprises generating a two-dimensional (2-D) object representation of the saved texture, and saving the 2-D object representation to the at least one data store.

20. A method according to claim 18 further comprising accessing the data store that includes the saved texture, selecting the saved texture, and displaying the saved texture using the system interface.

21. A method of using a computer program product embodied in a computer-readable storage medium for sharing digital content, the computer program product comprising a first computing environment and a second computing environment, each of the first and second computing environments comprising a data store, a digital image system in data communication with the data store, and a system interface in data communication with the digital image system, the method comprising:
accessing the data store that includes a plurality of digital content objects, each of the plurality of digital content objects defined as a tile;
selecting a subset of the plurality of tiles, the subset defined as selected tiles;
selecting a geometric output shape;
generating a respective rendering of each of the selected tiles, wherein each rendering has a perimeter;
combining the respective renderings to form a texture defined as a three-dimensional (3-D) object representation of the selected tiles having the geometric output shape, wherein the respective perimeters of any adjacent pair of the respective renderings in the texture are substantially abutting;
staging, using the first computing environment, a copy of the texture, defined as a first texture, to the data store accessible from the second computing environment;
transmitting, using the first computing environment, an invitation to access the copy of the first texture from the second computing environment;
accessing, using the second computing environment, the copy of the first texture staged from the first computing environment; and
displaying the first texture using the second computing environment.

22. A method according to claim 21 wherein transmitting the invitation to access the first texture comprises
generating a two-dimensional (2-D) object representation of the first texture, and
sending a message from the first computing environment to the second computing environment, wherein the message comprises the 2-D object representation of the first texture.

23. A method according to claim 21 further comprising at least one step selected from the group consisting of
editing, using the second computing environment, the first texture to create an edited texture;
saving the first texture to the at least one data store accessible from the second computing environment; and
deleting the first texture from the at least one data store accessible from a second computing environment.

24. A method according to claim 23 further comprising the steps of:
staging, using the second computing environment, a copy of the edited texture, defined as a second texture, to the data store accessible from the first computing environment;
transmitting, using the second computing environment, an invitation to access the second texture from the first computing environment.

25. A method according to claim 23 further comprising at least one step selected from the group consisting of:
staging, from the second computing environment to the data store accessible from the first computing environment, an object that includes cumulative edits applied to the first texture at the second computing environment to generate the edited texture, the object defined as a delta object;
transmitting, using the second computing environment, an invitation to access the delta object from the first computing environment;
accessing, using the first computing environment, the delta object;
applying, using the first computing environment, the delta object to change the texture to match the second texture.
